(19) United States
(12) Patent Application Publication
(10) Pub. No.: US 2015/0178032 A1
(43) Pub. Date: Jun. 25, 2015

(54) APPARATUSES AND METHODS FOR USING REMOTE MULTIMEDIA SINK DEVICES

(71) Applicant: QUALCOMM Incorporated, San Diego, CA (US)

(72) Inventors: Alexander Gantman, Yokneam (IL); Eugene Yasman, Karmiel (IL)

(21) Appl. No.: 14/533,507

(22) Filed: Nov. 5, 2014

Related U.S. Application Data
(60) Provisional application No. 61/918,370, filed on Dec. 19, 2013.

(51) Int. Cl. G06F 3/14; G06T 15/00; G06T 11/00; G06T 15/10; G06T 15/04; G09G 5/00; G06T 11/20; G06T 1/20; G06T 1/60

(52) U.S. Cl. CPC G06F 3/1407; G06T 1/20; G06T 15/005; G06T 11/001; G06T 1/60; G06T 15/04; G09G 5/006; G06T 11/20; G06T 15/10; G06T 2200/28; G06T 2200/04; G09G 2370/16; G06F 2211/002

(57) ABSTRACT

Aspects disclosed in the detailed description include apparatuses and methods for using remote multimedia sink devices. Exemplary aspects of the present disclosure provide a multimedia remote display system comprising a multimedia source device configured to discover a remote multimedia sink device, which has a graphics processing unit (GPU) and supports a wireless network interface. The multimedia source device is also configured to handle the remote multimedia sink device as a local high-speed peripheral device, and opportunistically apply compression to a multimedia stream before rendering the multimedia stream on the remote multimedia sink device. By handling the remote multimedia sink device as a local high-speed peripheral device, and opportunistically applying compression to the multimedia stream, high-definition (HD) multimedia content may be rendered on the remote multimedia sink device without adversely impacting quality of the HD multimedia content.

### PRIORITY CLAIM

The present application claims priority to U.S. Provisional Patent Application Ser. No. 61/918,370 filed on Dec. 19, 2013 and entitled “SYSTEMS AND METHODS FOR USING A REMOTE DISPLAY,” which is incorporated herein by reference in its entirety.

### BACKGROUND

I. Field of the Disclosure

The technology of the disclosure relates generally to controlling presentation of graphical content on remote multimedia sink devices.

II. Background

Mobile communication devices have become increasingly common in current society. The prevalence of these mobile devices is driven in part by the many functions that are now enabled on such devices. Demand for such functions increases processing capability requirements for the mobile devices. As a result, the mobile devices have evolved from being pure communication tools to becoming sophisticated mobile entertainment centers.

Concurrent with the rise in popularity of mobile computing devices is the explosive growth of high-definition (HD) and ultra-HD (UHD) multimedia content (e.g., three-dimensional (3D) games, HD videos, UHD videos, and high-resolution digital images) generated and/or consumed by the mobile computing devices. However, the ability to view HD and UHD multimedia content (whether generated locally or received from a remote source) on the mobile computing devices is hampered by relatively small screens in the mobile computing devices.

In an effort to overcome limitations of the small screens and improve multimedia experiences for end users, wireless display technologies such as wireless-fidelity (Wi-Fi) Miracast™ have been developed in recent years and become increasingly popular. In a Wi-Fi Miracast™ system, the mobile computing devices are configured to be multimedia sources, and a remote display device is configured to be a multimedia sink. Multimedia content is transmitted from the multimedia source to the multimedia sink over a Wi-Fi channel and subsequently decoded and/or rendered on the remote display device. Transmitting HD and UHD multimedia content, especially vector-based 3D multimedia content, such as 3D gaming content and computer-aided design (CAD) content, to the remote display device typically requires a large amount of wireless bandwidth due to an increasing demand for higher resolution and frame rate. To mitigate the impact of bandwidth insufficiency, the mobile computing devices are forced to apply lossy compression on the HD and UHD multimedia content before transmitting to the remote display device. Lossy compression may adversely impact the quality of the HD and UHD multimedia content, which is especially acute for 3D graphics with fine edges.

### SUMMARY OF THE DISCLOSURE

Aspects disclosed in the detailed description include apparatuses and methods for using remote multimedia sink devices. Exemplary aspects of the present disclosure provide a multimedia remote display system comprising a multimedia source device configured to discover a remote multimedia sink device, which has a graphics processing unit (GPU) and supports a wireless network interface. The multimedia source device is also configured to handle the remote multimedia sink device as a local high-speed peripheral device, and opportunistically apply compression to textures and non-vector parts of a multimedia stream before rendering the multimedia stream on the remote multimedia sink device. By handling the remote multimedia sink device as a local high-speed peripheral device, and opportunistically applying compression to the textures and non-vector parts of the multimedia stream, multimedia content may be redrawn and rendered on the remote multimedia sink device of any resolution without adversely impacting the quality of the multimedia content.

In this regard in one aspect, a multimedia remote display system is provided. The multimedia remote display system comprises a multimedia source device. The multimedia source device comprises at least one source network interface configured to be coupled to at least one remote multimedia sink device over at least one wireless communication medium. The multimedia source device also comprises at least one peripheral interface communicatively coupled to the at least one source network interface. The multimedia source device also comprises a control system communicatively coupled to the at least one peripheral interface. The control system is configured to receive at least one multimedia stream to be rendered on the at least one remote multimedia sink device. The control system is also configured to discover the at least one remote multimedia sink device through the at least one peripheral interface. The control system is also configured to load a GPU driver if the at least one remote multimedia sink device is determined to comprise a remote GPU. The control system is also configured to pass the at least one multimedia stream to the at least one peripheral interface for transmission to the at least one remote multimedia sink device.

In another aspect, a multimedia remote display system is disclosed. The multimedia remote display system comprises a multimedia source device. The multimedia source device comprises a means for receiving a multimedia stream. The multimedia source device also comprises a means for discovering a remote multimedia sink device. The multimedia source device also comprises a means for loading a GPU driver if the remote multimedia sink device is determined to comprise a remote GPU. The multimedia source device also comprises a control system configured to filter the multimedia stream to determine if the multimedia stream comprises a texture component and a geometry component. The control system is also configured to apply compression on the multimedia stream if the multimedia stream is determined to comprise the texture component and the geometry component. The control system is also configured to transfer the multimedia stream to the remote multimedia sink device for rendering. The control system is also configured to present the multimedia stream on the remote multimedia sink device.

In another aspect, a method for rendering a multimedia stream on a remote multimedia sink device is provided. The method comprises receiving the multimedia stream. The method also comprises discovering the remote multimedia sink device. The method also comprises loading a GPU driver if the remote multimedia sink device is determined to comprise a remote GPU. The method also comprises filtering the multimedia stream to determine if the multimedia stream comprises a texture component and a geometry component. The method also comprises applying compression on the multimedia stream if the multimedia stream is determined to comprise the texture component and the geometry component. The method also comprises transferring the multimedia stream to the remote multimedia sink device for rendering. The method also comprises presenting the multimedia stream on the remote multimedia sink device.

In another aspect, a remote display system is provided. The remote display system comprises a multimedia source device. The multimedia source device comprises a control system. The control system comprises a GPU driver. The multimedia source device also comprises a peripheral interface communicatively coupled to the control system. The multimedia source device also comprises at least one source network interface communicatively coupled to the control system through the peripheral interface. The remote display system also comprises a remote multimedia sink device. The remote multimedia sink device comprises at least one remote network interface coupled to the at least one source network interface over a wireless communication medium. The remote multimedia sink device also comprises a sink controller communicatively coupled to the at least one remote network interface. The remote multimedia sink device also comprises a remote GPU communicatively coupled to the sink controller. The remote multimedia sink device also comprises a remote display interface communicatively coupled to the sink controller and the remote GPU. The remote display system also comprises a remote display device coupled to the remote display interface over a remote display cable.

### BRIEF DESCRIPTION OF THE FIGURES

FIG. 1 is a block diagram of an exemplary conventional wireless display system comprising a mobile terminal as a multimedia source device and a docking station as a remote multimedia sink device, wherein the wireless display system is configured to operate according to aspects defined by the wireless-fidelity (Wi-Fi) Miracast™ specification;

FIG. 2 is a block diagram of an exemplary multimedia remote display system, wherein a multimedia source device is configured to render a multimedia stream on a remote multimedia sink device according to exemplary aspects of the present disclosure;

FIG. 3 is a flowchart of an exemplary multimedia remote display process for rendering the multimedia stream on the remote multimedia sink device in FIG. 2 according to exemplary aspects of the present disclosure; and

FIG. 4 is a flowchart of an exemplary multimedia stream compression process sequence conducted by the multimedia source device and the remote multimedia sink device in FIG. 2 according to exemplary aspects of the present disclosure.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include apparatuses and methods for using remote multimedia sink devices. Exemplary aspects of the present disclosure provide a multimedia remote display system comprising a multimedia source device configured to discover a remote multimedia sink device, which has a graphics processing unit (GPU) and supports a wireless network interface. The multimedia source device is also configured to handle the remote multimedia sink device as a local high-speed peripheral device, and opportunistically apply compression to textures and non-vector parts of a multimedia stream before rendering the multimedia stream on the remote multimedia sink device. By handling the remote multimedia sink device as a local high-speed peripheral device, and opportunistically applying compression to the textures and non-vector parts of the multimedia stream, multimedia content may be redrawn and rendered on the remote multimedia sink device of any resolution without adversely impacting the quality of the multimedia content.

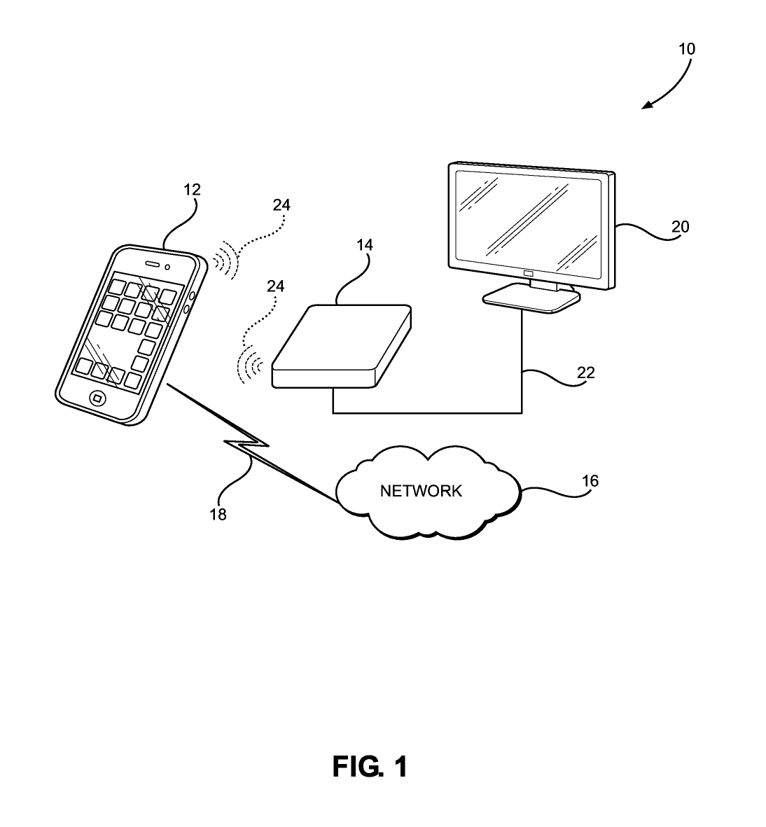

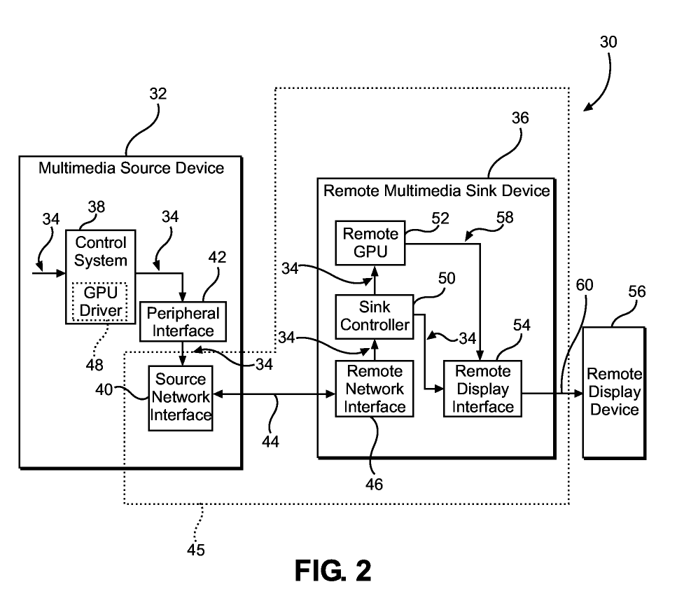

Before discussing aspects of the multimedia remote display system that includes specific aspects of the present disclosure, a brief overview of a conventional wireless display system configured according to the wireless-fidelity (Wi-Fi) Miracast™ specification is provided with reference to FIG. 1 to provide a contrast relative to exemplary aspects of the present disclosure and thereby illustrate advantages of exemplary aspects of the present disclosure. The discussion of exemplary aspects of the multimedia remote display system starts in FIG. 2.

In this regard, FIG. 1 is a block diagram of an exemplary conventional wireless display system 10 comprising a mobile terminal 12 configured as a multimedia source device and a docking station 14 configured as a remote multimedia sink device. The wireless display system 10 is configured to operate according to aspects defined by the Wi-Fi Miracast™ specification. The mobile terminal 12 may be connected to a wireless network 16 over a wireless communication medium 18. In a non-limiting example, the wireless network 16 may be a wireless wide area network (WWAN) such as a second generation (2G) WWAN, a third generation (3G) WWAN, a fourth generation (4G) WWAN, or a long-term evolution (LTE) WWAN. In another non-limiting example, the wireless network 16 may be a wireless local area network (WLAN). The docking station 14 is coupled to a display 20 over a remote display cable 22. In an exemplary aspect, the docking station 14 may be incorporated into the display 20. The display 20 can include any type of display, including but not limited to a cathode ray tube (CRT), a liquid crystal display (LCD), a light emitting diode (LED) display, a plasma display, a television, a projector, a computer monitor, etc. The mobile terminal 12 and the docking station 14 are configured to communicate over a Wi-Fi connection 24. In an exemplary example, the Wi-Fi connection 24 may be a peer-to-peer (P2P) connection operating in either a 2.4 gigahertz (GHz) band or a 5 GHz band.

In the wireless display system 10, the mobile terminal 12 is configured to transmit multimedia content over the Wi-Fi connection 24 to the docking station 14, which in turn renders the multimedia content on the display 20. The multimedia content may come from different sources. In a non-limiting example, the multimedia content may be streaming multimedia content received by the mobile terminal 12 from the wireless network 16. In another non-limiting example, the multimedia content may be pre-downloaded from the Internet and stored in a data storage medium (e.g., flash memory) in the mobile terminal 12 or attached to the mobile terminal 12. In yet another non-limiting example, the mobile terminal 12 may contemporaneously generate the multimedia content using an embedded camera and/or a GPU.

With continuing reference to FIG. 1, transmitting the multimedia content from the mobile terminal 12 to the docking station 14 requires substantial bandwidth in the Wi-Fi connection 24. In general, the amount of bandwidth required to transmit the multimedia content depends primarily on two factors, which are the bitrate and frame rate of the multimedia content. The bitrate is a quality indicator of the multimedia content when the multimedia content is generated. Higher bitrate means that more data are used to describe the multimedia content, thus providing the multimedia content with increased granularity and detail. The multimedia content is generated and rendered in units of frames. The frame rate, therefore, determines how fast the multimedia content can be rendered at the display 20. Higher frame rate usually leads to better user experiences when viewing the multimedia content. For instance, two-dimensional (2D) and three-dimensional (3D) gaming content typically require at least 60 frame-per-second (fps) frame rates to achieve decent user experiences. Higher frame rate, however, also means shorter frame duration. For instance, a 30 fps frame rate has an approximate frame duration of 33 milliseconds. When the frame rate increases from 30 fps to 60 fps, the frame duration is halved. At a 60 fps frame rate, if the bitrate of the multimedia content held steady, the amount of multimedia content to be transmitted in the frame duration doubles the amount of multimedia content transmitted at the 30 fps frame rate. As a result, the Wi-Fi connection 24 must provide twice the bandwidth to support the 60 fps frame rate. Understandably, even more bandwidth will be required from the Wi-Fi connection 24 when the frame rate further increases to 120 fps and 240 fps to support such applications as slow motion movies.

Unfortunately, the Wi-Fi connection 24 may not have sufficient bandwidth to support increased multimedia content bitrate and multimedia content frame rate. Consequently, the mobile terminal 12 is forced to compress the multimedia content before transmission to the docking station 14 over the Wi-Fi connection 24. Multimedia compression can be loosely categorized as either lossy compression or lossless compression. When a lossy compression, which is also referred to as lousy compression in some cases, is applied on the multimedia content, some aspects of the multimedia content are lost permanently and cannot be recovered when the multimedia content is decompressed and rendered. Typically the higher the compression ratio, the more aspects of the multimedia content are lost permanently and a lower multimedia content quality will result. In this regard, lossy compression lessens bandwidth demand on the Wi-Fi connection 24 by sacrificing quality of the multimedia content. According to present release of the Wi-Fi Miracast™ specification, the multimedia content may be compressed according to a motion picture experts group (MPEG) H.264 standard, which is one form of the lossy compression described above. Lossless compression, in contrast, allows the multimedia content to be perfectly reconstructed after decompression. However, the lossless compression does little to ease the bandwidth demand on the Wi-Fi connection 24. The docking station 14, in turn, must decompress the multimedia content before rendering on the display 20. In this regard, multimedia content compression and decompression increase end-to-end latency in the wireless display system 10, thus making it difficult to support graphic intensive and latency sensitive applications, such as 2D and 3D games, in the wireless display system 10. Thus, there is room for improved multimedia experiences in wireless environments.

In this regard, FIG. 2 is a block diagram of an exemplary multimedia remote display system 30, wherein a multimedia source device 32 is configured to render at least one multimedia stream 34 on at least one remote multimedia sink device 36 according to exemplary aspects of the present disclosure. In a non-limiting example, the multimedia source device 32 may be a smartphone, a phablet, a tablet, a laptop computer, a desktop computer, or a gaming console. The multimedia source device 32 comprises a control system 38, which is configured to receive the multimedia stream 34. In a non-limiting example, the multimedia stream 34 may carry a standard-definition (SD) video, a high-definition (HD) video, 2D graphics, 3D graphics or other multimedia content. The multimedia stream 34 may be provided from a variety of sources. In a non-limiting example, the multimedia source device 32 may receive the multimedia stream 34 over-the-air through a WWAN, such as a code-division multiple access (CDMA) network, a wideband CDMA (WCDMA) network, a long-term evolution (LTE) network, or a WLAN such as a Wi-Fi network. In another non-limiting example, the multimedia source device 32 may retrieve the multimedia stream 34 from a data storage medium (not shown), such as a flash memory, a hard drive, a compact disc (CD), etc., that is either embedded in the multimedia source device 32 or attached to the multimedia source device 32. In yet another non-limiting example, the multimedia source device 32 may contemporaneously generate the multimedia stream 34 using an embedded camera (not shown) (e.g., a single camera, a dual-camera, or an array camera) and/or an embedded GPU (not shown). Furthermore, the multimedia source device 32 may generate the multimedia stream 34 locally in an interactive or an offline way.

The multimedia source device 32 comprises at least one source network interface 40 and at least one peripheral interface 42. The peripheral interface 42 is communicatively coupled to the control system 38 and the source network interface 40, thus enabling communication between the control system 38 and the source network interface 40. The source network interface 40 is coupled to at least one wireless communication medium 44, which is shared by at least one remote network interface 46 in the remote multimedia sink device 36. Through the source network interface 40, the control system 38 is able to discover the remote multimedia sink device 36 and subsequently establish a wireless connection to the remote multimedia sink device 36. In a non-limiting example, the remote multimedia sink device 36 is a wireless gigabit (WiGig) bus extension (WBE) device, the wireless communication medium 44 is a WiGig communication medium, and the source network interface 40 and the remote network interface 46 are both WBE compliant network interfaces.

With reference to FIG. 2, WiGig is a short-range wireless communication technology designed to operate on the unlicensed 60 GHz frequency band and support a data transmission of rate up to 7 gigabit-per-second (Gbps). In fact, the data transmission rate of WiGig is comparable to or even higher than data transmission rates of many wired communication technologies. For instance, a universal serial bus (USB) version 3.0 cable can only support a data transmission rate of up to 5 Gbps. For this reason, it is possible for the control system 38 to treat the remote multimedia sink device 36 as if it is a local peripheral device 45 when the remote multimedia sink device 36 is determined to be the WBE device. In this regard, the peripheral interface 42 is configured to support the source network interface 40, the wireless communication medium 44, and the remote multimedia sink device 36 collectively as the local peripheral device 45 in the multimedia source device 32. In a non-limiting example, the peripheral interface 42 may be a peripheral component interconnect (PCI) express (PCIe) interface.

As previously mentioned, the multimedia stream 34 may carry the SD video, the HD video, 2D graphics, 3D graphics or other multimedia content. In a non-limiting example, 2D graphics and 3D graphics are encoded into an open graphics library (OpenGL) format, which may comprise a texture component and a geometry component (e.g., vertexes and polygons). In another non-limiting example, the SD video and the HD video may be encoded into a MPEG video format (e.g., H.263, H.264, etc.) that does not comprise the texture component and the geometry component. In this regard, the control system 38 is configured to determine if the multimedia stream 34 comprises the texture component and the geometry component. In a non-limiting example, a GPU driver filter (not shown) may be employed by the control system 38 to filter the texture component and the geometry component out of the multimedia stream 34. If the multimedia stream 34 comprises the texture component and the geometry component, the control system 38 then loads a GPU driver 48 to apply compression to the multimedia stream 34 according to aspects of the present disclosure. If the multimedia stream 34 does not comprise the texture component and the geometry component, the control system 38 passes the multimedia stream 34 directly to the peripheral interface 42 for transmitting to the remote multimedia sink device 36.

The GPU driver 48 receives the multimedia stream 34 that comprises the texture component and the geometry component. In a non-limiting example, the GPU driver filter (not shown) may have already separated the texture component from the geometry component, thus allowing the GPU driver 48 to apply lossy compression and lossless compression on the texture component and the geometry component, respectively. Because the multimedia stream 34 is generated and rendered in frames, the compression is performed on a per-frame basis and repeated for each frame in the multimedia stream 34. Subsequently, the control system 38, and/or the GPU driver filter (not shown) contained therein, passes the multimedia stream 34 to the peripheral interface 42 for rendering on the remote multimedia sink device 36. Each frame in the multimedia stream 34 now comprises lossy-compressed texture component and lossless-compressed geometry component. In addition, each frame in the multimedia stream 34 also contains a lossy compression algorithm and a lossless compression algorithm used to generate the lossy-compressed texture component and the lossless-compressed geometry component, respectively. By applying lossy compression on the texture component, more bandwidth in the wireless communication medium 44 may be made available for transmitting the multimedia stream 34. Additionally, the remote multimedia sink device 36 may also cache repetitively-used textures and/or geometrical objects to further conserve bandwidth in the wireless communication medium 44 and improve end-to-end processing latency. Consequently, it may also be possible to increase the bitrate of the multimedia stream 34. As discussed previously in FIG. 1, the bitrate is a quality indicator of the multimedia stream 34. Higher bitrate means that more data are used to describe the multimedia stream 34, thus providing the multimedia stream 34 with increased granularity or detail.

With continuing reference to FIG. 2, the remote network interface 46 receives the multimedia stream 34 over the wireless communication medium 44 and provides the multimedia stream 34 to a sink controller 50. The sink controller 50 is configured to determine if the multimedia stream 34 comprises the lossy-compressed texture component and the lossless-compressed geometry component. If the multimedia stream 34 comprises the lossy-compressed texture component and the lossless-compressed geometry component, the sink controller 50 then provides the multimedia stream 34 to a remote GPU 52 for further processing. If the multimedia stream 34 does not comprise the lossy-compressed texture component and the lossless-compressed geometry component, the sink controller 50 passes the multimedia stream 34 directly to a remote display interface 54 for rendering on a remote display device 56.

The remote GPU 52 is configured to regenerate a graphics content 58 based on the lossy-compressed texture component and the lossless-compressed geometry component in the multimedia stream 34. The remote GPU 52 then provides the graphics content 58 to the remote display interface 54 for rendering on the remote display device 56. The remote display device 56 is coupled to the remote display interface 54 by a remote display cable 60. In a non-limiting example, the remote display device 56 may be a cathode ray tube (CRT), a liquid crystal display (LCD), a light emitting diode (LED) display, a plasma display, a television, a projector, or a computer monitor. In another non-limiting example, the remote display cable 60 may be a high definition multimedia interface (HDMI) cable, a universal serial bus (USB) cable, a digital visual interface (DVI) cable, a composite video cable, or a video graphic array (VGA) cable. In yet another non-limiting example, the remote GPU 52 may be integrated with the remote display device 56, thus eliminating the remote display cable 60.

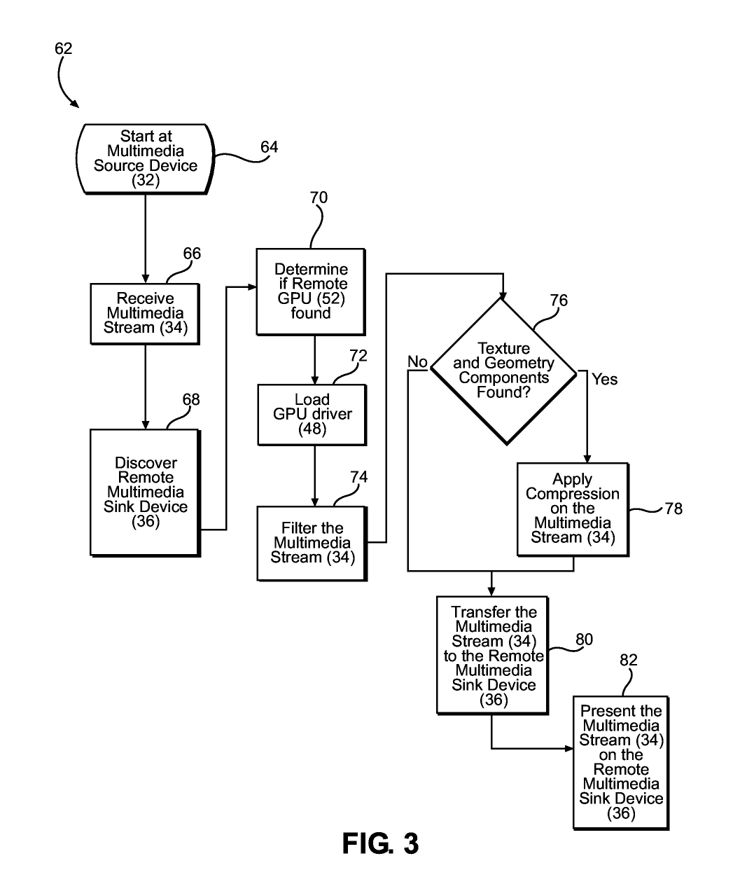

For further understanding of the multimedia remote display system 30, FIG. 3 is a flowchart of an exemplary multimedia remote display process 62 for rendering the multimedia stream 34 on the remote multimedia sink device 36 in FIG. 2 according to exemplary aspects of the present disclosure. Elements of FIG. 2 are referenced in connection to FIG. 3 and will not be re-described herein.

The multimedia remote display process 62 starts at the multimedia source device 32 (block 64). The multimedia source device 32 receives the multimedia stream 34 (block 66), which is also a means for receiving the multimedia stream 34. The multimedia stream 34 is intended to be rendered on the remote multimedia sink device 36. The multimedia source device 32 subsequently discovers the remote multimedia sink device 36 (block 68), which is also a means for discovering the remote multimedia sink device 36. The multimedia source device 32 subsequently establishes a wireless connection to the remote multimedia sink device 36 through the source network interface 40. In a non-limiting example, after establishing the wireless connection to the remote multimedia sink device 36, the multimedia source device 32 is able to further determine if the remote multimedia sink device 36 is a WBE device. If the remote multimedia sink device 36 is a WBE device, the multimedia source device 32 is configured to treat the remote multimedia sink device 36 as the local peripheral device 45 and subsequently communicate with the remote multimedia sink device 36 through the peripheral interface 42. The multimedia source device 32 may also rescan the peripheral interface 42 periodically to ensure the remote multimedia sink device 36 remains connected. Further, the multimedia source device 32 determines if the remote GPU 52 is found (block 70).

With continuing reference to FIG. 3, on detection of the remote GPU 52, the multimedia source device 32 loads the GPU driver 48 (block 72), which is also a means for loading the GPU driver 48. The GPU driver 48 is designed to filter the multimedia stream 34 (block 74). In particular, the GPU driver 48 determines if the texture component and the geometry component are found in the multimedia stream 34 (block 76). If the texture component and the geometry component are found in the multimedia stream 34, the GPU driver 48 then applies compression on the multimedia stream 34 (block 78). More specifically in a non-limiting example, the GPU driver 48 applies lossy compression on the texture component and lossless compression on the geometry component, respectively. As a result, the multimedia stream 34 now comprises the compressed texture component and the compressed geometry component. If, however, the texture component and the geometry component are not found in the multimedia stream 34, compression will not be applied on the multimedia stream 34. In either event, the multimedia source device 32 transfers the multimedia stream 34 to the remote multimedia sink device 36 (block 80). At the remote multimedia sink device 36, the multimedia stream 34 is provided to the remote GPU 52 if the multimedia stream 34 is determined to comprise the lossy-compressed texture component and the lossless-compressed geometry component. In contrast, the multimedia stream 34 is not provided to the remote GPU 52 if the multimedia stream 34 does not comprise the lossy-compressed texture component and the lossless-compressed geometry component. In either event, the multimedia stream 34 is presented on the remote multimedia sink device 36 (block 82).

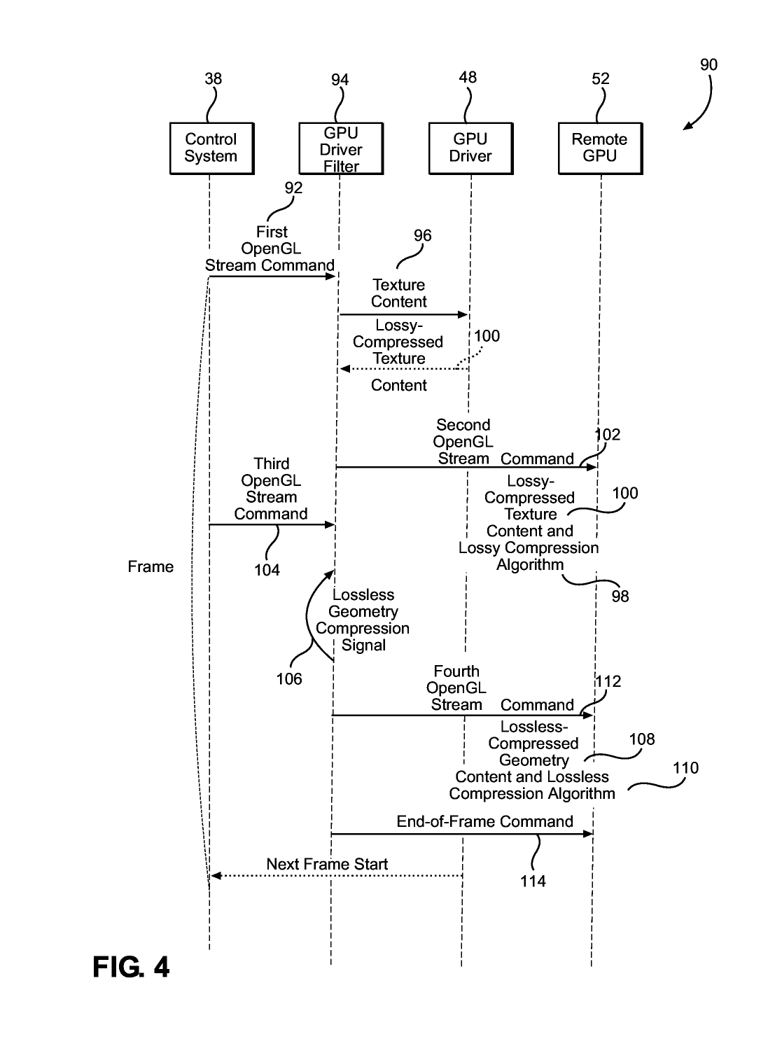

As illustrated above, a centerpiece of the multimedia remote display process 62 involves applying compression on the multimedia stream 34 when the multimedia stream 34 is determined to comprise the texture component and the geometry component. In this regard, FIG. 4 is a flowchart of an exemplary multimedia stream compression process sequence 90 conducted by the multimedia source device 32 and the remote multimedia sink device 36 in FIG. 2 according to exemplary aspects of the present disclosure. Elements of FIG. 2 are referenced in connection with FIG. 4 and will not be re-described herein.

As previously discussed, the multimedia stream 34 is generated and rendered in frames. Hence, the multimedia stream compression process sequence 90 is repeated for each frame in the multimedia stream 34. At the beginning of a frame, the control system 38 issues a first OpenGL stream command 92 to a GPU driver filter 94. In a non-limiting example, the GPU driver filter 94 may be implemented as a software function as part of the control system 38 or the GPU driver 48. The GPU driver filter 94 then provides a texture content 96 to the GPU driver 48. In response, the GPU driver 48 applies compression on the texture content 96 based on a lossy compression algorithm 98 and returns a lossy-compressed texture content 100 to the GPU driver filter 94. The GPU driver filter 94 subsequently issues a second OpenGL stream command 102 to the remote GPU 52 while passing the lossy-compressed texture content 100 along with the lossy compression algorithm 98. In a non-limiting example, the remote GPU 52 may later use the lossy compression algorithm 98 to decompress the lossy-compressed texture content 100.

With continuing reference to FIG. 4, the control system 38 subsequently issues a third OpenGL stream command 104 to the GPU driver filter 94. The GPU driver filter 94 then identifies the geometry content with a lossless geometry compression signal 106 and generates a lossless-compressed geometry content 108 based on a lossless compression algorithm 110. The GPU driver filter 94 subsequently issue a fourth OpenGL stream command 112 to the remote GPU 52 while passing the lossless-compressed geometry content 108 along with the lossless compression algorithm 110. In a non-limiting example, the remote GPU 52 may later use the lossless compression algorithm 110 to decompress the lossless-compressed geometry content 108. Finally, the GPU driver filter 94 issues an end-of-frame command 114 to the remote GPU 52, which concludes the multimedia stream 34 compression for the frame. In the multimedia stream compression process sequence 90, the lossy-compressed texture content 100 and the lossless-compressed geometry content 108 are passed individually to the remote GPU 52. However, it is also possible to multiplex the lossy-compressed texture content 100 with the lossless-compressed geometry content 108 before passing to the remote GPU 52 for decompression and rendering. Furthermore, the remote GPU 52 may selectively cache the lossy-compressed texture content 100 and the lossless-compressed geometry content 108 to conserve bandwidth and reduce processing latency.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A multimedia remote display system comprising:
a multimedia source device, comprising:
at least one source network interface configured to be coupled to at least one remote multimedia sink device over at least one wireless communication medium;
at least one peripheral interface communicatively coupled to the at least one source network interface; and
a control system communicatively coupled to the at least one peripheral interface, wherein the control system is configured to:
receive at least one multimedia stream to be rendered on the at least one remote multimedia sink device;
discover the at least one remote multimedia sink device through the at least one peripheral interface;
load a graphics processing unit (GPU) driver if the at least one remote multimedia sink device is determined to comprise a remote GPU; and
pass the at least one multimedia stream to the at least one peripheral interface for transmission to the at least one remote multimedia sink device.

2. The multimedia remote display system of claim 1, wherein the at least one wireless communication medium is a wireless gigabit (WiGig) communication medium and the at least one source network interface is a WiGig bus extension (WBE) compliant network interface.

3. The multimedia remote display system of claim 1, wherein the at least one source network interface is configured to operate on a 60 gigahertz (GHz) frequency band.

4. The multimedia remote display system of claim 1, wherein the at least one peripheral interface is a peripheral component interconnect (PCI) express (PCIe) interface configured to support the at least one source network interface and the at least one remote multimedia sink device collectively as a local peripheral device.

5. The multimedia remote display system of claim 1, wherein the at least one multimedia stream carries two-dimensional (2D) graphic data or three-dimensional (3D) graphic data encoded into an open graphics library (OpenGL) graphic formats.

6. The multimedia remote display system of claim 1, wherein the GPU driver is configured to detect if the at least one multimedia stream comprises a texture component and a geometry component.

7. The multimedia remote display system of claim 6, wherein the GPU driver is configured to apply lossy compression on the texture component.

8. The multimedia remote display system of claim 6, wherein the GPU driver is configured to apply lossless compression on the geometry component.

9. The multimedia remote display system of claim 1, wherein the at least one multimedia stream carries standard-definition (SD) video or high-definition (HD) video encoded into a motion picture experts group (MPEG) video format.

10. The multimedia remote display system of claim 1, wherein the at least one multimedia stream is received from Internet, retrieved from a data storage medium, or generated by the multimedia source device.

11. The multimedia remote display system of claim 1, wherein the at least one remote multimedia sink device comprises:
at least one remote network interface configured to receive the at least one multimedia stream from the multimedia source device over the at least one wireless communication medium;
a remote display interface configured to support a remote display device;
a sink controller configured to:
receive the at least one multimedia stream from the at least one remote network interface;
provide the at least one multimedia stream to the remote GPU if the at least one multimedia stream comprises a texture component and a geometry component; and
pass the at least one multimedia stream to the remote display interface if the at least one multimedia stream does not comprise the texture component and the geometry component; and
the remote GPU configured to:
receive the at least one multimedia stream from the sink controller;
process the texture component and the geometry component to generate a graphics content; and
provide the graphics content to the remote display interface.

12. The multimedia remote display system of claim 11, wherein the remote GPU is configured to selectively cache the texture component and/or the geometry component.

13. The multimedia remote display system of claim 11, wherein the at least one remote multimedia sink device is a wireless gigabit (WiGig) bus extension (WBE) device and the at least one remote network interface is a WBE compliant network interface.

14. A multimedia remote display system comprising:
a multimedia source device, comprising:
a means for receiving a multimedia stream;
a means for discovering a remote multimedia sink device;
a means for loading a graphics processing unit (GPU) driver if the remote multimedia sink device is determined to comprise a remote GPU; and
a control system configured to:
filter the multimedia stream to determine if the multimedia stream comprises a texture component and a geometry component;
apply compression on the multimedia stream if the multimedia stream is determined to comprise the texture component and the geometry component;
transfer the multimedia stream to the remote multimedia sink device for rendering; and
present the multimedia stream on the remote multimedia sink device.

15. A method for rendering a multimedia stream on a remote multimedia sink device, comprising:
receiving the multimedia stream;
discovering the remote multimedia sink device;
loading a graphics processing unit (GPU) driver if the remote multimedia sink device is determined to comprise a remote GPU;
filtering the multimedia stream to determine if the multimedia stream comprises a texture component and a geometry component;
applying compression on the multimedia stream if the multimedia stream is determined to comprise the texture component and the geometry component;
transferring the multimedia stream to the remote multimedia sink device for rendering; and
presenting the multimedia stream on the remote multimedia sink device.

16. The method of claim 15, wherein receiving the multimedia stream comprises receiving the multimedia stream encoded in an open graphics library (OpenGL) format, wherein the multimedia stream comprises the texture component and the geometry component.

17. The method of claim 15, wherein receiving the multimedia stream comprises receiving the multimedia stream encoded in a motion picture experts group (MPEG) video format, wherein the multimedia stream does not comprise the texture component and the geometry component.

18. The method of claim 15, wherein discovering the remote multimedia sink device comprises:
establishing a wireless connection with the remote multimedia sink device;
scanning a peripheral interface; and
rescanning the peripheral interface periodically.

19. The method of claim 18, wherein:
the remote multimedia sink device is a wireless gigabit (WiGib) bus extension (WBE) device; and
the peripheral interface is a peripheral component interconnect (PCI) express (PCIe) interface.

20. The method of claim 15, wherein the GPU driver is configured to filter the multimedia stream to determine if the multimedia stream comprises the texture component and the geometry component.

21. The method of claim 15, wherein applying compression on the multimedia stream comprises:
separating the texture component from the multimedia stream; and
applying lossy compression on the texture component.

22. The method of claim 15, wherein applying compression on the multimedia stream comprises:
separating the geometry component from the multimedia stream; and
applying lossless compression on the geometry component.

23. The method of claim 15, wherein applying compression on the multimedia stream comprises:
separating the texture component from the multimedia stream;
applying lossy compression on the texture component;
separating the geometry component from the multimedia stream; and
applying lossless compression on the geometry component.

24. The method of claim 15, wherein presenting the multimedia stream comprises:
receiving the multimedia stream by the remote multimedia sink device;
providing the multimedia stream to the remote GPU if the multimedia stream comprises the texture component and the geometry component; and
rendering the multimedia stream on a remote display device coupled to a remote display interface in the remote multimedia sink device if the multimedia stream does not comprise the texture component and the geometry component.

25. The method of claim 24, wherein the remote GPU is configured to:
generate a graphics content based on the texture component and the geometry component; and
render the graphics content on the remote display device coupled to the remote display interface in the remote multimedia sink device.

26. A remote display system comprising:
a multimedia source device, comprising:
a control system, comprising a graphics processing unit (GPU) driver;
a peripheral interface communicatively coupled to the control system; and
at least one source network interface communicatively coupled to the control system through the peripheral interface;
a remote multimedia sink device, comprising:
at least one remote network interface coupled to the at least one source network interface over a wireless communication medium;
a sink controller communicatively coupled to the at least one remote network interface;
a remote GPU communicatively coupled to the sink controller; and
a remote display interface communicatively coupled to the sink controller and the remote GPU; and
a remote display device coupled to the remote display interface over a remote display cable.

27. The remote display system of claim 26, wherein the multimedia source device is a device selected from the group consisting of: a smartphone; a phablet; a tablet; a laptop computer; a desktop computer; and a gaming console.

28. The remote display system of claim 26, wherein the wireless communication medium is a wireless gigabit (WiGig) communication medium.

29. The remote display system of claim 26, wherein the at least one source network interface is a wireless gigabit (WiGig) bus extension (WBE) compliant network interface.

30. The remote display system of claim 26, wherein the remote multimedia sink device is a WBE device and the at least one remote network interface is a WBE compliant network interface.
